(19) United States
(12) Patent Application Publication
(10) Pub. No.: US 2006/0174623 A1
(43) Pub. Date: Aug. 10, 2006

(54) Vehicular rankine cycle system

(75) Inventors: Akihisa Sato, Wako-shi (JP); Tadashi Kurotani, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/336,851

(22) Filed: Jan. 23, 2006

(30) Foreign Application Priority Data
Jan. 24, 2005 (JP) 2005-014994

(51) Int. Cl. F03G 6/00; B60L 8/00; B60K 16/00

(52) U.S. Cl. 60/641.8

(57) ABSTRACT

A vehicular Rankine cycle system includes: an evaporator for heating a liquid-phase working medium with thermal energy of exhaust gas of an engine so as to generate a gas-phase working medium; a displacement type expander for converting thermal energy of the gas-phase working medium generated by the evaporator into mechanical energy; gas-phase working medium controller for controlling the temperature and/or pressure of the gas-phase working medium supplied to the expander at a target temperature and/or a target pressure by changing the amount of liquid-phase working medium supplied to the evaporator; and throttle opening degree controller for controlling a throttle opening degree of the engine by correcting an accelerator opening degree directed by a driver. The throttle opening degree controller controls the throttle opening degree so as to suppress a rise in thermal energy of the exhaust gas, thus inhibiting the temperature and/or pressure of the gas-phase working medium from overshooting the target temperature and/or the target pressure.

### CROSS-REFERENCE TO RELATED APPLICATIONS

The present application claims priority under 35 USC 119 to Japanese Patent Application No. 2005-14994 filed on Jan. 24, 2005 the entire contents of which are hereby incorporated by reference.

### BACKGROUND OF THE INVENTION

1. Field of the Invention

The present invention relates to a vehicular Rankine cycle system that is operated by exhaust gas of an engine having the throttle opening degree controlled by a drive-by-wire system.

2. Description of the Related Art

Japanese Patent Application Laid-open No. 2002-115574 discloses an arrangement in which an accelerator pedal and a throttle valve are electrically connected via a drive-by-wire system, wherein when a driver directs the accelerator opening degree to be increased, a feeling of insufficient output due to a response lag of a Rankine cycle system is compensated for by further increasing the throttle opening degree by a correction amount in addition to a value proportional to the accelerator opening degree, and when the driver directs the accelerator opening degree to be decreased, a feeling of excessive output due to a response lag of the Rankine cycle system is compensated for by further decreasing the throttle opening degree by a correction amount in addition to a value proportional to the accelerator opening degree.

As shown in FIG. 9, the efficiency of an evaporator and the efficiency of an expander of a Rankine cycle system change according to steam temperature; as the steam temperature increases, the efficiency of the evaporator decreases and the efficiency of the expander increases, whereas as the steam temperature decreases, the efficiency of the evaporator increases and the efficiency of the expander decreases, and there is therefore an optimum steam temperature at which the overall efficiency of the two becomes a maximum. It is therefore desirable to control the temperature of steam supplied from the evaporator to the expander at the optimum steam temperature (target steam temperature).

As shown in FIG. 10, when the accelerator opening degree is increased stepwise by depressing an accelerator pedal when accelerating rapidly from an idling state, starting rapidly from a cold state, etc., the engine rotational speed increases and the exhaust gas energy also increases stepwise. When the exhaust gas energy increases, the temperature of steam generated in the evaporator increases beyond the target steam temperature (ref. region a), but due to the heat capacity of the evaporator the increase in the steam temperature has a time lag relative to the increase in the accelerator opening degree. When the steam temperature increases in this way, feedback control is carried out so as to increase the amount of water supplied to the evaporator in order to suppress the increase in the steam temperature (ref. region b). Since, due to the increase in the amount of water supplied, the amount of steam supplied from the evaporator to the expander increases and the steam pressure increases, feedback control is carried out so as to increase the rotational speed of the expander in order to decrease the steam pressure. However, if the increase in the steam pressure is rapid, the rotational speed of the expander reaches a maximum rotational speed and the steam pressure cannot be decreased sufficiently (ref. region c), and there is a possibility that the steam pressure might overshoot an upper limit pressure (ref. region d) and the operating efficiency of the expander might be degraded or the durability might be adversely affected.

### SUMMARY OF THE INVENTION

The present invention has been accomplished under the above-mentioned circumstances, and it is an object thereof to inhibit, in a Rankine cycle system-equipped vehicle, an excessive increase in the pressure and/or temperature of a gas-phase working medium supplied from an evaporator to an expander when the accelerator opening degree is rapidly increased.

A front wheel Wf and a rear wheel Wr of embodiments correspond to the driven wheel of the present invention, an expander 12 and a second motor/generator MG23 of the embodiments correspond to the auxiliary drive source of the present invention, and a drive-by-wire system 25 of the embodiments corresponds to the throttle opening degree control means of the present invention.

In order to achieve the above-mentioned object, according to a first feature of the invention, there is provided a vehicular Rankine cycle system comprising: an evaporator for heating a liquid-phase working medium with thermal energy of exhaust gas of an engine so as to generate a gas-phase working medium; a displacement type expander for converting thermal energy of the gas-phase working medium generated by the evaporator into mechanical energy; gas-phase working medium control means for controlling the temperature and/or pressure of the gas-phase working medium supplied to the expander at a target temperature and/or a target pressure by changing the amount of liquid-phase working medium supplied to the evaporator; and throttle opening degree control means for controlling a throttle opening degree of the engine by correcting an accelerator opening degree directed by a driver; wherein the throttle opening degree control means controls the throttle opening degree so as to suppress a rise in thermal energy of the exhaust gas, thus inhibiting the temperature and/or pressure of the gas-phase working medium from overshooting the target temperature and/or the target pressure.

With the first feature, when the accelerator opening degree increases rapidly by accelerating rapidly from an idling state, starting rapidly from a cold state, etc., even if the gas-phase working medium control means attempts to control the temperature or pressure of the gas-phase working medium supplied to the expander at the target temperature or the target pressure by increasing the amount of liquid-phase working medium supplied to the evaporator, there is a possibility that the temperature or pressure of the gas-phase working medium might overshoot the target temperature or the target pressure, but controlling the throttle opening degree by the throttle opening degree control means so as to suppress a rise in thermal energy of the exhaust gas enables the temperature or pressure of the gas-phase working medium to be inhibited from overshooting the target temperature or the target pressure, thus preventing the efficiency and durability of the expander from deteriorating.

According to a second feature of the present invention, in addition to the first feature, the throttle opening degree control means inhibits the temperature and/or pressure of the gas-phase working medium from undershooting the target temperature and/or the target pressure.

With the second feature, since the throttle opening degree control means inhibits the temperature or pressure of the gas-phase working medium from undershooting the target temperature or the target pressure, it is possible to maintain the target temperature or the target pressure at which the expander is operated with the highest efficiency, thus minimizing any decrease in the efficiency of the expander.

According to a third feature of the present invention, in addition to the first feature, the system further comprises an auxiliary drive source for driving a driven wheel by assisting output of the engine, and an insufficient output of the engine relative to a driving force corresponding to the accelerator opening degree directed by the driver is compensated for by driving the auxiliary drive source, the engine having the throttle opening degree controlled by the throttle opening degree control means.

With the third feature, even if the output of the engine having the throttle opening degree controlled by the throttle opening degree control means is insufficient for a driving force corresponding to the accelerator opening degree directed by the driver, since the insufficient output is compensated for by the auxiliary drive source, which assists the output of the engine and drives the driven wheel, it is possible to drive the driven wheel with an output corresponding to the accelerator opening degree directed by the driver, thus eliminating any disagreeable sensation for the driver.

According to a fourth feature of the present invention, in addition to the third feature, the auxiliary drive source is an expander of the Rankine cycle system.

With the fourth feature, since the expander of the Rankine cycle system is utilized as the auxiliary drive source, a special auxiliary drive source is not needed.

According to a fifth feature of the present invention, in addition to the third feature, the auxiliary drive source is driven by electric power generated by the output of the expander of the Rankine cycle system.

With the fifth feature, since the auxiliary drive source is driven with electric power generated by the output of the expander of the Rankine cycle system, it is possible to drive the auxiliary drive source at any time, irrespective of the time of operation of the expander.

The above-mentioned object, other objects, characteristics, and advantages of the present invention will become apparent from preferred embodiments that will be described in detail below by reference to the attached drawings.

### BRIEF DESCRIPTION OF THE DRAWINGS

FIG. 1 to FIG. 7 show a first embodiment of the present invention;

FIG. 1 is a diagram showing the overall arrangement of a Rankine cycle system,

FIG. 2 is a hardware layout (L/O) diagram of a control system of the Rankine cycle system,

FIG. 3 is a diagram showing a control block of a Rankine controller,

FIGS. 4A, 4B, and 4C are graphs for explaining the operation of a drive-by-wire system,

FIG. 5 is a flowchart for explaining the operation of the drive-by-wire system,

FIG. 6 is a time chart for explaining the operation of the Rankine cycle system,

FIG. 7 is a graph showing the relationship between exhaust gas energy and exhaust gas change amount limit value.

FIG. 8 is a diagram showing another mode of application of a second motor/generator in a second embodiment.

FIG. 9 is a graph showing the relationship between optimum steam temperature and maximum overall efficiency of an evaporator and an expander.

FIG. 10 is a time chart for explaining the operation of a conventional Rankine cycle system.

### DESCRIPTION OF PREFERRED EMBODIMENT

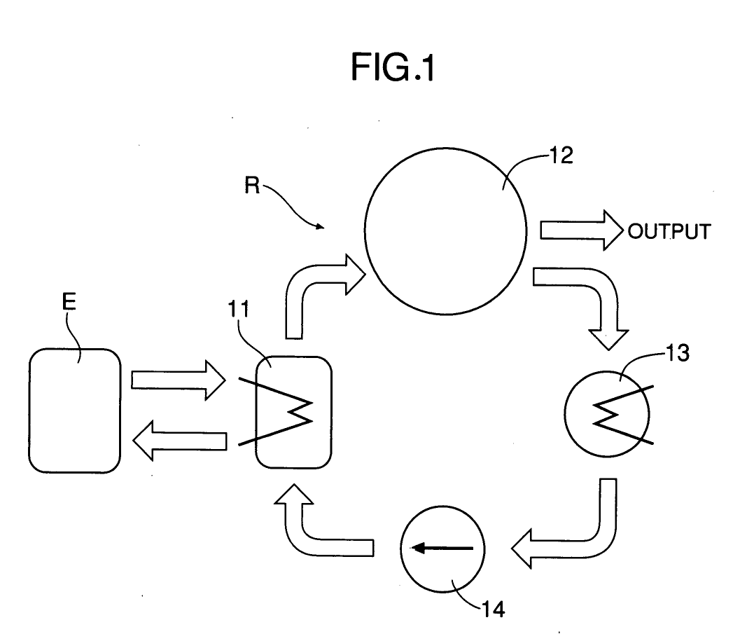

FIG. 1 shows the overall arrangement of a Rankine cycle system R to which the present invention is applied. The Rankine cycle system R, which recovers thermal energy of exhaust gas of an engine E and converts it into mechanical energy, includes an evaporator 11, an expander 12, a condenser 13, and a water supply pump 14, the evaporator 11 heating water with the exhaust gas discharged by the engine E so as to generate high temperature, high pressure steam, the expander 12 being operated by the high temperature, high pressure steam generated by the evaporator 11 so as to generate mechanical energy, the condenser 13 cooling decreased temperature, decreased pressure steam that has completed work in the expander 12 so as to turn it back into water, and the water supply pump 14 pressurizing water discharged from the condenser 13 and re-supplying it to the evaporator 11.

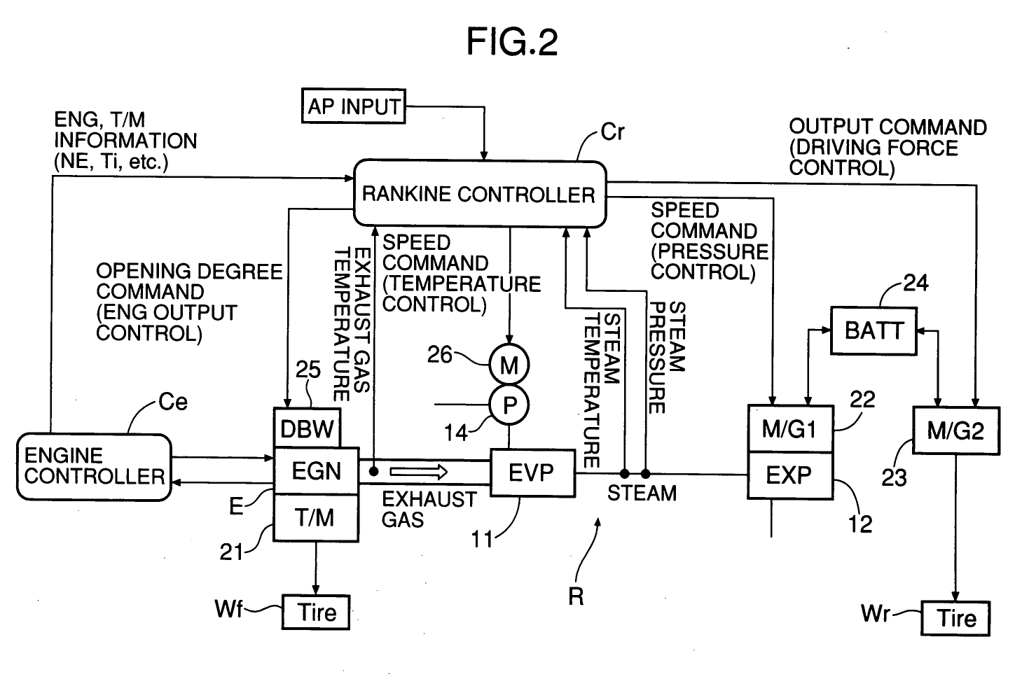

As shown in FIG. 2, a front wheel Wf is connected to the engine E via a transmission 21, a first motor/generator 22 is connected to the expander 12, a rear wheel Wr is connected to a second motor/generator 23, and a battery 24 is connected to the first and second motor/generators 22 and 23. Inputted into a Rankine controller Cr for controlling the Rankine cycle system R are an engine rotational speed, a fuel injection quantity, an air/fuel ratio, etc. from an engine controller Ce for controlling the engine E, a degree of opening of an accelerator pedal operated by a driver, an exhaust gas temperature of the engine E, and a temperature and pressure of the high temperature, high pressure steam supplied from the evaporator 11 to the expander 12. The Rankine controller Cr controls, based on these signals, operation of a drive-by-wire system 25 for controlling the throttle opening degree of the engine E, operation of a pump drive motor 26 for driving the water supply pump 14 supplying water to the evaporator 11, operation of the first motor/generator 22, and operation of the second motor/generator 23.

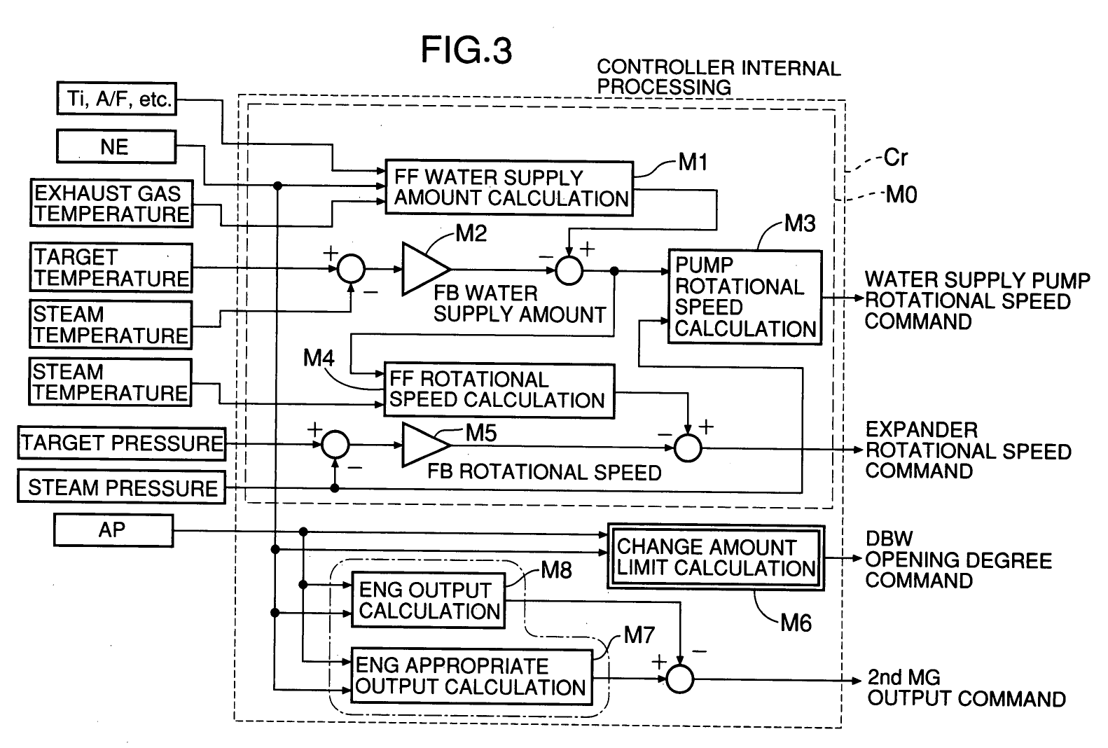

FIG. 3 shows a circuit arrangement of the Rankine controller Cr. Feedforward water supply amount calculation means Ml calculates a feedforward water supply amount for the evaporator 11 based on an engine rotational speed NE, a fuel injection quantity Ti, an air/fuel ratio A/F, and an exhaust gas temperature. The deviation of an actual steam temperature from a target steam temperature of the high temperature, high pressure steam supplied from the evaporator 11 to the expander 12 is inputted into feedback water supply amount calculation means M2, and a feedback water supply amount for the evaporator 11 is calculated therein by multiplying the deviation by a predetermined gain. A difference between the feedforward water supply amount calculated by the feedforward water supply amount calculation means M1 and the feedback water supply amount calculated by the feedback water supply amount calculation means M2 is inputted into pump rotational speed calculation means M3, a rotational speed command value for the water supply pump 14 is calculated therein by using the actual steam pressure of the high temperature, high pressure steam supplied from the evaporator 11 to the expander 12, and the rotational speed command value is outputted to the water supply pump 14.

Feedforward rotational speed calculation means M4 calculates a feedforward rotational speed for the expander 12 based on the difference between the feedforward water supply amount and the feedback water supply amount and the actual steam temperature of the high temperature, high pressure steam supplied from the evaporator 11 to the expander 12. A deviation of the actual steam pressure from the target steam pressure of the high temperature, high pressure steam supplied from the evaporator 11 to the expander 12 is inputted into feedback rotational speed calculation means M5, and a feedback rotational speed for the expander 12 is calculated therein by multiplying the deviation by a predetermined gain. A difference between the feedforward rotational speed calculated by the feedforward rotational speed calculation means M4 and the feedback rotational speed calculated by the feedback rotational speed calculation means M5 is outputted as a rotational speed command value for the expander 12.

The feedforward water supply amount calculation means M1, the feedback water supply amount calculation means M2, the pump rotational speed calculation means M3, the feedforward rotational speed calculation means M4, and the feedback rotational speed calculation means M5 together form gas-phase working medium control means M0.

Change amount limit calculation means M6 outputs a drive-by-wire degree of opening command value in order to control the rate of change in the throttle opening degree of the engine E by the drive-by-wire system 25.

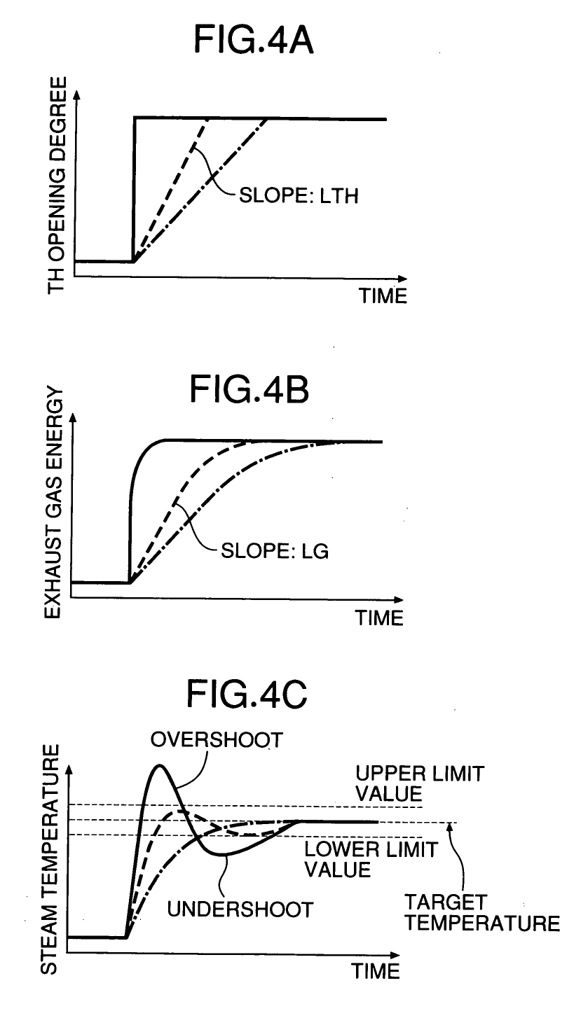

That is, when the driver rapidly depresses the accelerator pedal and the accelerator opening degree increases stepwise, if the throttle opening degree is increased simply in response to the increase in the accelerator opening degree as shown by the solid line in FIG. 4A, the energy of the exhaust gas increases stepwise in response to an increase in the load on the engine E as shown by the solid line in FIG. 4B. In this process, even if the amount of water supplied to the evaporator 11 is increased, the temperature of the high temperature, high pressure steam coming out of the evaporator 11 overshoots an upper limit value as shown by the solid line in FIG. 4C, and there is a possibility that the efficiency and durability of the expander 12 might deteriorate. Furthermore, as shown by the solid line in FIG. 4C, since feedback control is carried out so as to supply excessive water after overshooting, there is a possibility that the steam temperature might undershoot a lower limit value.

On the other hand, if the rate of increase in the throttle opening degree relative to the rate of increase in the accelerator opening degree is excessively suppressed by the drive-by-wire system 25 as shown by the dotted-dashed line in FIG. 4A, the rate of increase in the energy of the exhaust gas decreases excessively as shown by the dotted-dashed line in FIG. 4B. As a result, the temperature of the high temperature, high pressure steam coming out of the evaporator 11 does not even once exceed a target temperature (a steam temperature at which the efficiency of the Rankine cycle system R becomes a maximum) as shown by the dotted-dashed line in FIG. 4C, the operating efficiency of the expander 12 decreases, and since it takes time to reach the target temperature, there is a response lag to maximum efficiency operation, and the expander 12 cannot generate sufficient output.

In contrast, if the rate of increase in the throttle opening degree relative to the rate of increase in the accelerator opening degree is appropriately decreased by the drive-by-wire system 25 as shown by the dashed line in FIG. 4A, the rate of increase in the energy of exhaust gas appropriately decreases as shown by the dashed line in FIG. 4B. As a result, the temperature of the high temperature, high pressure steam coming out of the evaporator 11 exceeds the target temperature once as shown by the dashed line in FIG. 4C, then decreases before reaching the upper limit value, and converges on the target temperature in the minimum time without decreasing below the lower limit value.

The drive-by-wire degree of opening command value shown by the dashed line in FIG. 4A is calculated by the change amount limit calculation means M6 as follows.

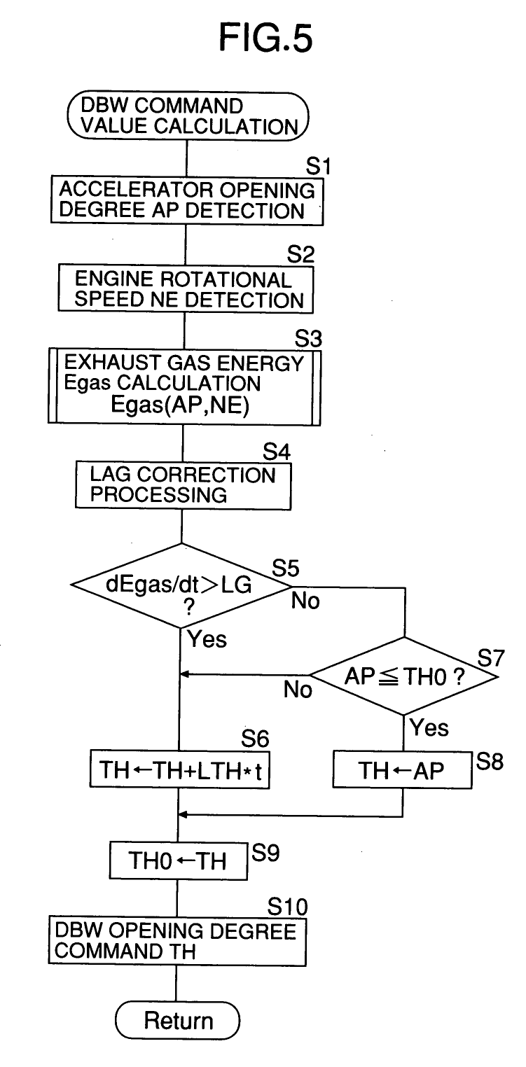

In step S1 of the flowchart of FIG. 5, an accelerator opening degree AP is detected, in step S2 the engine rotational speed NE is detected, and in step S3 an energy Egas of exhaust gas is calculated by carrying out a map lookup using the accelerator opening degree AP and the engine rotational speed NE. In the subsequent step S4, an estimated lag for the energy Egas of the exhaust gas is corrected, in step S5 the rate of change dEgas/dt of the energy of the exhaust gas over time is compared with an exhaust gas change amount limit value LG, and if
dEgas/dt>LG
holds, then in step S6 a throttle opening degree TH is updated, using a sampling time t, by TH+LTH*t. Here, LG is the slope of the dashed line in FIG. 4B, and dEgas/dt>LG means that the rate of change dEgas/dt of the energy of exhaust gas over time exceeds the optimum rate of change. Furthermore, LTH is the slope of the dashed line in FIG. 4A, and updating the throttle opening degree TH by TH+LTH*t means that the drive-by-wire system 25 increases the throttle opening degree by the slope of the dashed line in FIG. 4A.

If the answer in step S5 is NO, and if in step S7 the accelerator opening degree AP is not equal to or less than the previous value TH0 of the throttle opening degree, that is, the accelerator opening degree AP has increased, then in step S6 the throttle opening degree TH is updated. If in step S7 the accelerator opening degree AP is equal to or less than the previous value TH0 of the throttle opening degree, that is, the accelerator opening degree is constant or decreased, then in step S8 the accelerator opening degree AP is used as the throttle opening degree TH as it is.

In step S9, the throttle opening degree TH replaces the previous value TH0, and then in step S10 the throttle opening degree TH is used as the drive-by-wire degree of opening command value.

In this way, when the accelerator opening degree AP increases rapidly at a time when the engine E is accelerated rapidly from an idling state or is started rapidly from a cold state, even if the temperature or pressure of the high temperature, high pressure steam supplied to the expander 12 is controlled at the target temperature or the target pressure by increasing the amount of water supplied to the evaporator 11, there is a possibility that the temperature or pressure of the high temperature, high pressure steam might overshoot the target temperature or the target pressure. However, in this embodiment, when the accelerator pedal is depressed, the drive-by-wire system 25 inhibits the throttle opening degree TH from rapidly increasing to thus suppress a rise in thermal energy of the exhaust gas, and the temperature or pressure of the high temperature, high pressure steam is thereby prevented from overshooting the target temperature or the target pressure, thus preventing the efficiency and the durability of the expander 12 from deteriorating. Moreover, by increasing the throttle opening degree TH at an appropriate rate of increase, the temperature or pressure of the high temperature, high pressure steam is prevented from overshooting the target temperature or the target pressure, thus minimizing any decrease in output of the expander 12.

Returning to FIG. 3, engine appropriate output calculation means M7 calculates an engine output requested by the driver from a raw accelerator opening degree and the engine rotational speed, and engine output calculation means M8 calculates an actual engine output from the engine rotational speed and the actual throttle opening degree controlled by the drive-by-wire system 25. Since a difference between these two engine outputs corresponds to an insufficient engine output due to suppression of the throttle opening degree by the drive-by-wire system 25, this insufficient engine output is outputted as an output command value for the second motor/generator 23. As a result, the second motor/generator 23 drives the rear wheel Wr to thus assist driving of the front wheel Wf by the engine E so as to make the total output of the engine E and the second motor/generator 23 coincide with the output requested by the driver (that is, the accelerator opening degree), thus eliminating any disagreeable sensation for the driver.

As energy for driving the second motor/generator 23, electric power generated by the first motor/generator 22 driven by the expander 12 of the Rankine cycle system R and stored in the battery 24 is used. In this way, converting the mechanical energy outputted by the expander 12 into electrical energy with the first motor/generator 22 and storing it in the battery 24 allows the second motor/generator 23 to be driven at any time.

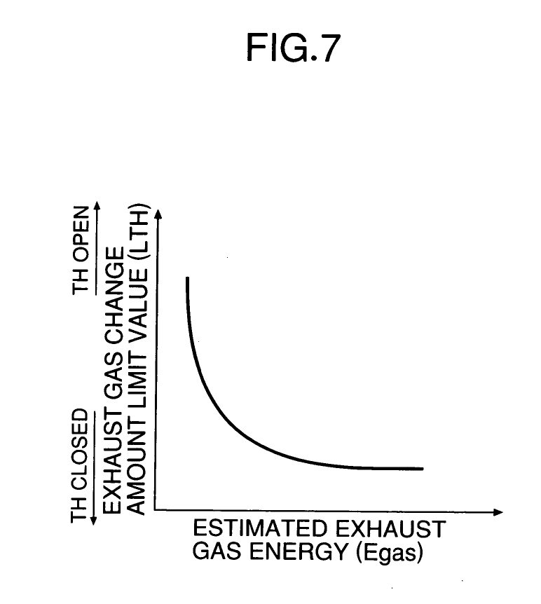

Although the exhaust gas change amount limit value LTH may be a constant value, since the larger the exhaust gas energy Egas, the easier it becomes for the steam pressure to overshoot, as shown in FIG. 7 the exhaust gas change amount limit value LTH may be reduced as the exhaust gas energy Egas increases.

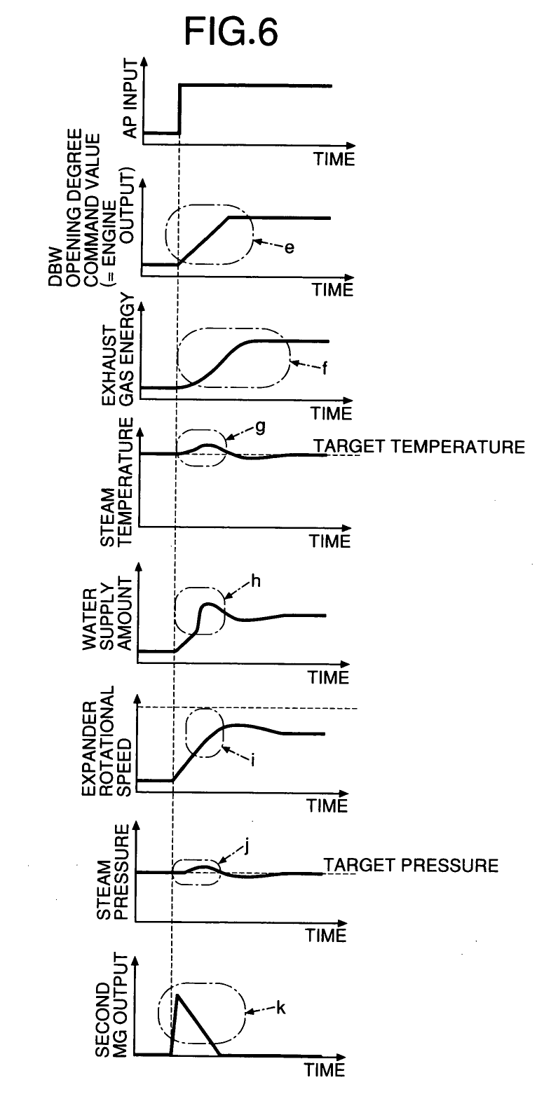

The above-mentioned operation is summarized as follows by reference to the time chart of FIG. 6.

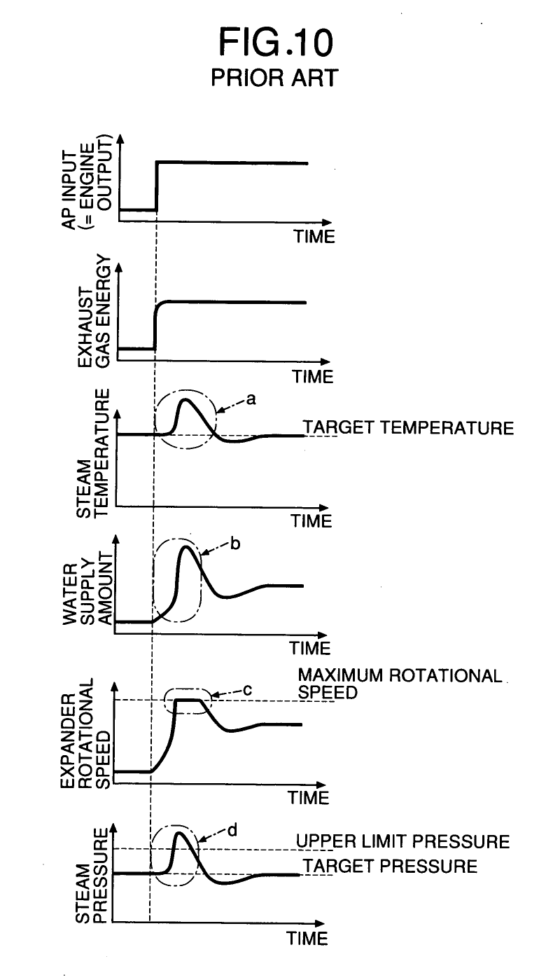

Even if the driver depresses the accelerator pedal when accelerating rapidly from an idling state, starting rapidly from a cold state, etc. and the accelerator opening degree increases stepwise, by increasing the drive-by-wire degree of opening command value slowly (ref. region e), the energy of the exhaust gas increases slowly (ref. region f). Although the temperature of the high temperature, high pressure steam generated by the evaporator 11 increases accompanying the increase in energy of the exhaust gas, this increase in temperature is smaller (ref. region g) than that of a conventional arrangement (ref. FIG. 10). Although feedback control is carried out so that, when the steam temperature increases, the amount of water supplied to the evaporator 11 increases, since the increase in the amount of water supplied is suppressed to a low level (ref. region h), the increase in steam pressure also becomes small (ref. region j). As a result, it is unnecessary for there to be a large increase in the rotational speed of the expander 12 in order to decrease the steam pressure (ref. region i), and the rotational speed of the expander 12 does not reach a maximum rotational speed. Since the steam pressure is prevented from overshooting the upper limit pressure, it is possible to prevent the operating efficiency of the expander 12 from being reduced or the durability from being adversely affected.

Furthermore, in order to compensate for insufficient engine output due to suppression of the throttle opening degree by the drive-by-wire system 25, the second motor/generator 23 is driven (ref. region k) and the total output of the engine E and the second motor/generator 23 is made to coincide with the output requested by the driver, thereby enabling any disagreeable sensation for the driver to be eliminated.

Although the first embodiment of the present invention has been described above, the present invention can be modified in a variety of ways as long as the modifications do not depart from the subject matter of the present invention.

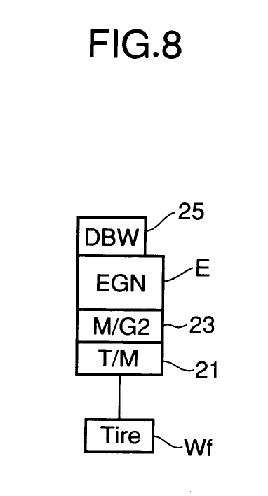

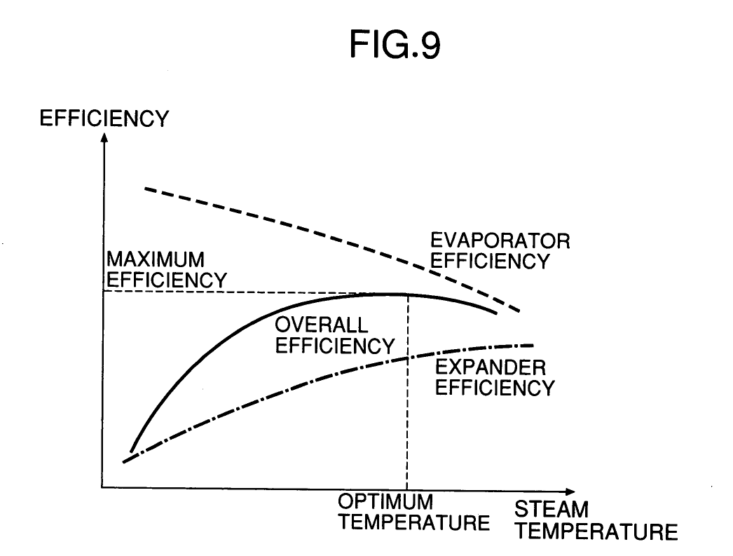

For example, in the first embodiment, the rear wheel Wr is driven by the second motor/generator 23, but as in a second embodiment shown in FIG. 8, a second motor/generator 23 may be disposed between an engine E and a transmission 21 and drive a front wheel Wf.

Moreover, in the embodiments, an insufficient engine output due to suppression of the throttle opening degree by the drive-by-wire system 25 is assisted by the output of the second motor/generator 23, but an insufficient engine output may be assisted directly by mechanical output of the expander 12 of the Rankine cycle system R.

What is claimed is:

1. A vehicular Rankine cycle system comprising:
an evaporator for heating a liquid-phase working medium with thermal energy of exhaust gas of an engine so as to generate a gas-phase working medium;
a displacement type expander for converting thermal energy of the gas-phase working medium generated by the evaporator into mechanical energy;
gas-phase working medium control means for controlling the temperature and/or pressure of the gas-phase working medium supplied to the expander at a target temperature and/or a target pressure by changing the amount of liquid-phase working medium supplied to the evaporator; and
throttle opening degree control means for controlling a throttle opening degree of the engine by correcting an accelerator opening degree directed by a driver;
wherein the throttle opening degree control means controls the throttle opening degree so as to suppress a rise in thermal energy of the exhaust gas, thus inhibiting the temperature and/or pressure of the gas-phase working medium from overshooting the target temperature and/or the target pressure.

2. The vehicular Rankine cycle system according to claim 1, wherein the throttle opening degree control means inhibits the temperature and/or pressure of the gas-phase working medium from undershooting the target temperature and/or the target pressure.

3. The vehicular Rankine cycle system according to claim 1, further comprising an auxiliary drive source for driving a driven wheel by assisting output of the engine, wherein an insufficient output of the engine relative to a driving force corresponding to the accelerator opening degree directed by the driver is compensated for by driving the auxiliary drive source, the engine having the throttle opening degree controlled by the throttle opening degree control means.

4. The vehicular Rankine cycle system according to claim 3, wherein the auxiliary drive source is an expander of the Rankine cycle system.

5. The vehicular Rankine cycle system according to claim 3, wherein the auxiliary drive source is driven by electric power generated by the output of the expander of the Rankine cycle system.
